(19) United States
(12) Patent Application Publication
(10) Pub. No.: US 2021/0097852 A1
(43) Pub. Date: Apr. 1, 2021

(54) MOVING ROBOT

(71) Applicant: LG ELECTRONICS INC., Seoul (KR)

(72) Inventor: Kyungho YOO, Seoul (KR)

(73) Assignee: LG ELECTRONICS INC., Seoul (KR)

(21) Appl. No.: 16/802,474

(22) Filed: Feb. 26, 2020

(30) Foreign Application Priority Data
Sep. 27, 2019 (KR) 10-2019-0120039

(51) Int. Cl. G08G 1/005; G06K 9/00; H04N 5/247

(52) U.S. Cl. CPC G08G 1/005; G06K 9/00825; G06K 9/4652; H04N 5/247; G06K 9/00664

(57) ABSTRACT

Disclosed herein is a moving robot including at least one motor configured to enable the moving robot to travel, a memory configured to store map data, at least one camera, and a processor configured to recognize a passage situation of a crosswalk during traveling operation based on the map data and a set traveling route, check a signal state of a traffic light corresponding to the crosswalk, recognize whether passage through the crosswalk is possible based on the checked signal state, and control the at least one motor to enable passage through the crosswalk based on a result of recognition.

### CROSS-REFERENCE TO RELATED APPLICATIONS

Pursuant to 35 U.S.C. § 119(a), this application claims the benefit of earlier filing date and right of priority to Korean Patent Application No. 10-2019-0120039, filed on Sep. 27, 2019, the contents of which are all hereby incorporated by reference herein in their entirety.

### BACKGROUND

The present disclosure relates to a moving robot and, more particularly, to a moving robot capable of passing a crosswalk during traveling.

A robot may refer to a machine that automatically processes or operates a given task by its own ability. The application fields of robots are generally classified into industrial robots, medical robots, aerospace robots, and underwater robots.

Recently, with development of self-driving technology, automatic control technology using sensors and communication technology, researches for applying robots to more various fields are ongoing.

Robots (moving robots), to which self-driving technology is applied, may perform various operations or provide various services while traveling indoors or outdoors.

Meanwhile, a robot traveling outdoors may mainly travel using a sidewalk. In this case, if necessary, the robot may pass a crosswalk during traveling.

The robot should recognize the state of a traffic light in order to pass the crosswalk. For example, a method of, at a robot, receiving information on the state of the traffic light from a control device of the traffic light via wireless communication may be considered. However, in this method, infrastructure needs to be established in advance. Considerable cost is required to implement the above-described method in a wide space. In addition, various unexpected situations should be detected in order for the robot to safely pass the crosswalk.

### SUMMARY

An object of the present disclosure is to provide a robot capable of safely passing a crosswalk during traveling.

Another object of the present disclosure is to provide a robot capable of efficiently performing obstacle detection operation during passage through a crosswalk.

A moving robot according to an embodiment includes at least one motor configured to enable the moving robot to travel, a memory configured to store map data, at least one camera, and a processor configured to recognize a passage situation of a crosswalk during traveling operation based on the map data and a set traveling route, check a signal state of a traffic light corresponding to the crosswalk, recognize whether passage through the crosswalk is possible based on the checked signal state, and control the at least one motor to enable passage through the crosswalk based on a result of recognition.

In some embodiments, the map data may include position information of the crosswalk, and the processor may be configured to recognize the passage situation of the crosswalk based on the position information of the crosswalk and position information of the moving robot.

In some embodiments, the map data may further include position information of the traffic light corresponding to the crosswalk, and the processor may be configured to control at least one camera to acquire an image including the traffic light based on the position information of the traffic light and check the signal state of the traffic light based on the acquired image.

In some embodiments, the processor may be configured to set a standby position based on the position information of the traffic light and control the at least one motor to wait at the set standby position.

In some embodiments, the processor may be configured to set, as the standby position, a position closest to a position facing the traffic light in a sidewalk region corresponding to the crosswalk.

In some embodiments, the processor may be configured to check at least one of a color, a shape or a position of a turned-on signal of the traffic light based on the acquired image and recognize whether passage through the crosswalk is possible based on a result of checking.

In some embodiments, the processor may be configured to acquire a result of recognizing the signal state from the acquired image via a learning model trained based on machine learning to recognize the signal state of the traffic light.

The processor may be configured to acquire an image of a first side via the at least one camera when it is recognized that passage through the crosswalk is possible, and the first side may be set based on a vehicle traveling direction of a driveway in which the crosswalk is installed.

In some embodiments, the processor may be configured to detect at least one obstacle from the image of the first side and control the at least one motor based on the detected at least one obstacle.

The processor may be configured to control the at least one motor not to enter the crosswalk, when approaching of any one of the at least one obstacle is recognized.

In some embodiments, the processor may be configured to estimate a movement direction and a movement speed of each of the at least one obstacle from the image of the first side, predict whether the at least one obstacle and the moving robot collide based on a result of estimation and control the at least one motor not to enter the crosswalk when collision is predicted.

The processor may be configured to control the at least one motor to enter the crosswalk when an approaching obstacle or an obstacle, collision with which is predicted, is not detected from the image of the first side.

In some embodiments, the processor may be configured to detect that the moving robot reaches a predetermined distance from a halfway point of the crosswalk based on the position information of the moving robot or the image acquired via the at least one camera, control the at least one camera to acquire an image of a second side opposite to the first side and control the at least one motor based on the image of the second side.

In some embodiments, the at least one camera may include a first camera disposed to face a front side of the moving robot, a second camera disposed to face the first side of the moving robot, and a third camera disposed to face the second side of the moving robot, and the processor may be configured to selectively activate any one of the second camera or the third camera to acquire the image of the first side or the image of the second side.

In some embodiments, the processor may be configured to acquire remaining time information of a passable signal of the traffic light corresponding to the crosswalk before entering the crosswalk, check whether passage through the crosswalk is possible based on the acquired remaining time information and control the at least motor to enable passage through the crosswalk or wait at a standby position of the crosswalk based on a result of checking.

In some embodiments, the processor may be configured to acquire remaining time information of a passable signal of the traffic light during passage through the crosswalk, calculate a traveling speed based on the acquired remaining time information and a remaining distance of the crosswalk and control the at least one motor according to the calculated traveling speed.

A moving robot according to another embodiment of the present disclosure includes at least one motor configured to enable the moving robot to travel, a memory configured to store map data, at least one camera, and a processor configured to recognize a passage situation of a crosswalk during traveling operation based on the map data and a set traveling route, control the at least one camera to acquire a side image of the moving robot, recognize whether passage through the crosswalk is possible based on the acquired side image and control the at least one motor to enable passage through the crosswalk based on a result of recognition.

In some embodiments, the at least one camera may include a first camera configured to a front image of the moving robot, a second camera configured to acquire a first side image of the moving robot, and a third camera configured to acquire a second side image of the moving robot, and the processor may be configured to activate at least one of the second camera or the third camera to acquire the side image of the moving robot, when the passage situation of the crosswalk is recognized.

In some embodiments, the processor may set priority of processing the side image to be higher than priority of processing the front image.

In some embodiments, each of the at least one camera may be rotatable about a vertical axis, the moving robot may include at least one rotary motor for rotating the at least one camera, and the processor may be configured to control a first rotary motor corresponding to the first camera to acquire the side image via the first camera of the at least one camera when the passage situation of the crosswalk is recognized, acquire the front image of the moving robot via the second camera of the at least one camera and set priority of processing the side image to be higher than priority of processing the front image.

### BRIEF DESCRIPTION OF THE DRAWINGS

FIG. 1 illustrates an AI device including a robot according to an embodiment of the present disclosure.

FIG. 2 illustrates an AI server connected to a robot according to an embodiment of the present disclosure.

FIG. 3 illustrates an AI system including a robot according to an embodiment of the present disclosure.

FIG. 4 is a block diagram illustrating the control configuration of a robot according to an embodiment of the present disclosure.

FIGS. 5 to 6 are views showing examples of an image acquiring unit provided in a robot.

FIG. 7 is a flowchart illustrating a crosswalk passage method of a robot according to an embodiment of the present disclosure.

FIG. 8 is a flowchart illustrating operation in which a robot according to an embodiment of the present disclosure recognizes whether passage through a crosswalk is possible via a traffic light corresponding to the crosswalk.

FIGS. 9 to 11 are views showing examples related to operation of the robot shown in FIG. 8.

FIG. 12 is a flowchart illustrating control operation when a robot according to an embodiment of the present disclosure passes a crosswalk.

FIGS. 13 to 15 are views showing examples related to operation of the robot shown in FIG. 12.

FIG. 16 is a flowchart illustrating an embodiment related to a crosswalk passage method of a robot.

FIG. 17 is a flowchart illustrating an embodiment related to a crosswalk passage method of a robot.

### DETAILED DESCRIPTION OF THE EMBODIMENTS

Description will now be given in detail according to exemplary embodiments disclosed herein, with reference to the accompanying drawings. The accompanying drawings are used to help easily understand the embodiments disclosed in this specification and it should be understood that the embodiments presented herein are not limited by the accompanying drawings. As such, the present disclosure should be construed to extend to any alterations, equivalents and substitutes in addition to those which are particularly set out in the accompanying drawings.

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

At this time, the self-driving vehicle may be regarded as a robot having a self-driving function.

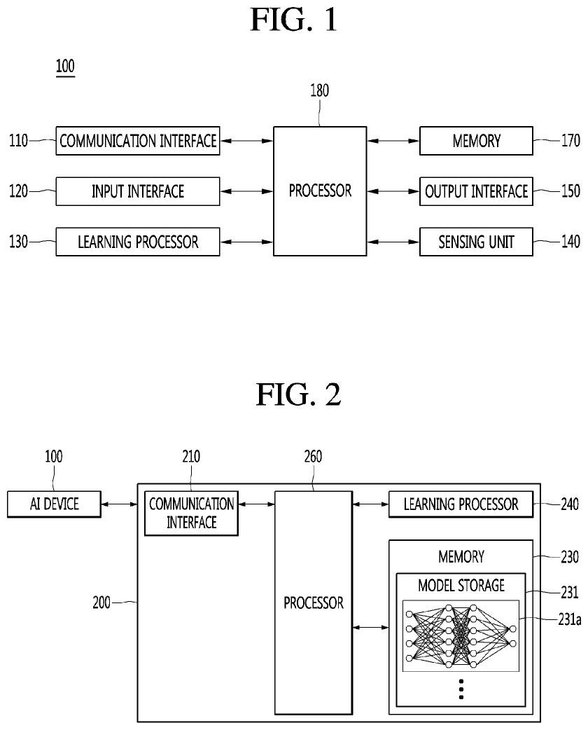

FIG. 1 illustrates an AI device 100 including a robot according to an embodiment of the present disclosure.

The AI device 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication interface 110, an input interface 120, a learning processor 130, a sensing unit 140, an output interface 150, a memory 170, and a processor 180.

The communication interface 110 may transmit and receive data to and from external devices such as other AI devices 100a to 100e and the AI server 200 by using wire/wireless communication technology. For example, the communication interface 110 may transmit and receive sensor information, a user input, a learning model, and a control signal to and from external devices.

The communication technology used by the communication interface 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

At this time, the input interface 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input interface 120 may acquire a learning data for model learning and an input data to be used when an output is acquired by using learning model. The input interface 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

At this time, the output interface 150 may include a display unit for outputting time information, a speaker for outputting auditory information, and a haptic module for outputting haptic information.

The memory 170 may store data that supports various functions of the AI device 100. For example, the memory 170 may store input data acquired by the input interface 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in memory 170. Furthermore, the processor 180 may operate two or more of the components included in the AI device 100 in combination so as to drive the application program.

FIG. 2 illustrates an AI server 200 connected to a robot according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. At this time, the AI server 200 may be included as a partial configuration of the AI device 100, and may perform at least part of the AI processing together.

The AI server 200 may include a communication interface 210, a memory 230, a learning processor 240, a processor 260, and the like.

The communication interface 210 can transmit and receive data to and from an external device such as the AI device 100.

The memory 230 may include a model storage 231. The model storage 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

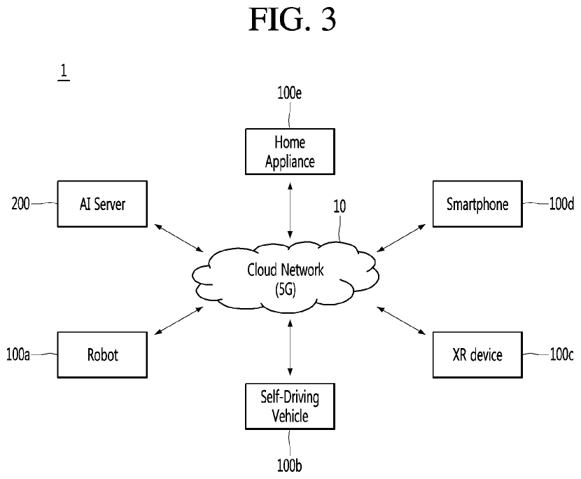

FIG. 3 illustrates an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the received input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

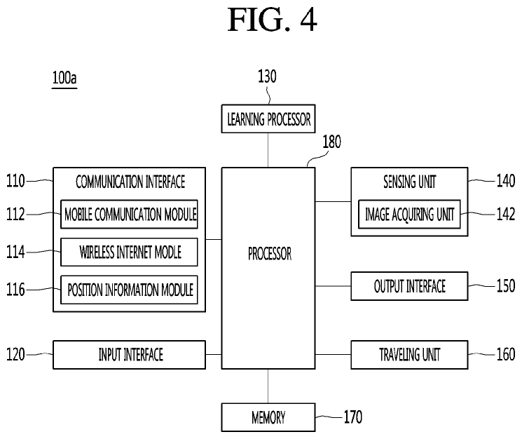

FIG. 4 is a block diagram illustrating the control configuration of a robot according to an embodiment of the present disclosure.

Referring to FIG. 4, the robot 100a may include a communication interface 110, an input interface 120, a learning processor 130, a sensing unit 140, an output interface 150, a traveling unit 160, a memory 170 and a processor 180. The components shown in FIG. 4 are examples for convenience of description and the robot 100a may include more or fewer components than the components shown in FIG. 4.

Meanwhile, the description related to the AI device 100 of FIG. 1 is similarly applicable to the robot 100a of the present disclosure and thus a repeated description of FIG. 1 will be omitted.

The communication interface 110 may include communication modules for connecting the robot 100a with a server, a mobile terminal or another robot over a network. Each of the communication modules may support any one of the communication technologies described above with reference to FIG. 1.

For example, the robot 100a may be connected to the network via an access point such as a router. Therefore, the robot 100a may provide various types of information acquired through the input interface 120 or the sensing unit 140 to the server or the mobile terminal over the network. In addition, the robot 100a may receive information, data, commands, etc. from the server or the mobile terminal.

Meanwhile, the communication interface 110 may include at least one of a mobile communication module 112, a wireless Internet module 114 and a position information module 116. The mobile communication module 112 may support various mobile communication schemes such long term evolution (LTE), 5G networks, etc. The wireless Internet module 114 may support various wireless Internet schemes such as Wi-Fi, wireless LAN, etc. The position information module 116 may support schemes such as global positioning system (GPS), global navigation satellite system (GNSS), etc.

For example, the robot 100a may acquire a variety of information such as map data and/or information related to a traveling route from a server or a mobile terminal via at least one of the mobile communication module 112 or the wireless Internet module 114.

In addition, the robot 100a may acquire information on the current position of the robot 100a via the mobile communication module 112, the wireless Internet module 114 and/or the position information module 116.

That is, the robot 100a may perform traveling operation using map data, a traveling route, and information on a current position.

The input interface 120 may include at least one input part for acquiring various types of data. For example, the at least one input part may include a physical input interface such as a button or a dial, a touch input interface such as a touchpad or a touch panel, a microphone for receiving user's speech or ambient sound of the robot 100a, etc. The user may input various types of requests or commands to the robot 100a through the input interface 120.

The sensing unit 140 may include at least one sensor for sensing a variety of surrounding information of the robot 100a. The sensing unit 140 may include an image acquiring unit 142 for acquiring the image of the surroundings of the robot 100a.

The image acquiring unit 142 may include at least one camera for acquiring the image of the surroundings of the robot 100a.

For example, the processor 180 may recognize a crosswalk, a traffic light, an obstacle, etc. from the image acquired via the image acquiring unit 142.

The image acquiring unit 142 will be described in greater detail with reference to the following drawings.

In some embodiments, the sensing unit 140 may include various sensors such as a proximity sensor for detecting an object such as a user approaching the robot 100a, an illuminance sensor for detecting the brightness of a space in which the robot 100a is disposed, a gyroscope sensor for detecting a rotation angle or a slope of the robot 100a, etc.

The output interface 150 may output various types of information or content related to operation or state of the robot 100a or various types of services, programs or applications executed in the robot 100a. For example, the output interface 150 may include a display, a speaker, etc.

The display may output the above-described various types of information or messages in the graphic form. The speaker may output the various types of information, messages or content in the form of speech or sound.

The traveling unit 160 is used to move (drive) the robot 100a and may include a driving motor, for example. The driving motor may be connected to at least one wheel provided on the lower part of the robot 100a to provide driving force for traveling of the robot 100a to the at least one wheel. For example, the traveling unit 160 may include at least one driving motor, and the processor 180 may control the at least one driving motor to adjust the traveling direction and/or the traveling speed of the robot 100a.

The memory 170 may store various types of data such as control data for controlling operation of the components included in the robot 100a, data for performing operation based on information acquired via the input interface 120 or information acquired via the sensing unit 140, etc.

In addition, the memory 170 may store program data of software modules or applications executed by at least one processor or controller included in the processor 180.

The memory 170 may include various storage devices such as a ROM, a RAM, an EEPROM, a flash drive, a hard drive, etc. in hardware.

The processor 180 may include at least one processor or controller for controlling operation of the robot 100a. For example, the processor 180 may include at least one CPU, application processor (AP), microcomputer, integrated circuit, application specific integrated circuit (ASIC), etc.

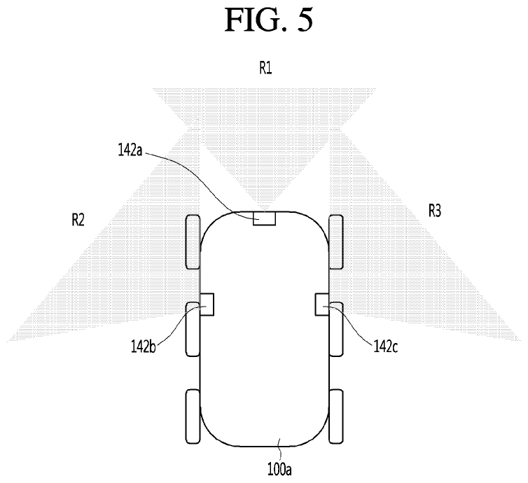

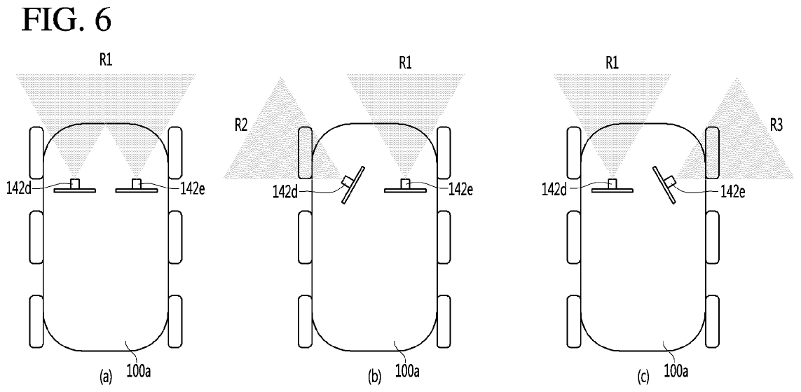

FIGS. 5 to 6 are views showing examples of an image acquiring unit provided in a robot.

Referring to FIG. 5, the image acquiring unit 142 may include a plurality of cameras 142a to 142c. The robot 100a is generally implemented to travel forward and the plurality of cameras 142a to 142c may be disposed to acquire the images of the front and side of the robot 100a.

Specifically, the first camera 142a of the plurality of cameras 142a to 142c may be disposed to face the front of the robot 100a and may acquire an image of a front region R1 of the robot 100a.

For example, the processor 180 may recognize a crosswalk and a traffic light from the image acquired via the first camera 142a.

The second camera 142b of the plurality of cameras 142a to 142c may be disposed to face the first side (e.g., the left side) of the robot 100a and may acquire the image of the first side region R2 of the robot 100a.

The third camera 142c of the plurality of cameras 142a to 142c may be disposed to face the second side (e.g., the right side) of the robot 100a and may acquire the image of the second side region R3 of the robot 100a.

The processor 180 may recognize an approaching obstacle during passage through a crosswalk from the images acquired via the second camera 142b and the third camera 142c.

Meanwhile, the most dangerous obstacle when the robot 100a passes the crosswalk may be a vehicle traveling on a driveway. Accordingly, the robot 100a needs to accurately detect approaching and collision possibility of a vehicle, for safe passage through the crosswalk.

Meanwhile, when a driveway with a crosswalk is a two-way driveway, the passage directions of vehicles are opposite to each other with respect to the halfway point of the crosswalk. That is, the processor 180 may drive only any one of the second camera 142b or the third camera 142c according to the position of the robot 100a to detect whether an obstacle (vehicle) approaches. Therefore, by reducing the processing load of the processor 180, it is possible to rapidly detect an obstacle and to efficiently reduce power consumption according to driving of the camera.

Referring to the examples of FIG. 6, the image acquiring unit 142 may include a first camera 142d and a second camera 142e rotatably provided with respect to a vertical axis. In this case, the robot 100a may include rotary motors (not shown) for rotating the first camera 142d and the second camera 142e.

The processor 180 may acquire the image of at least one of the front region R1, the first side region R2 and the second side region R3 via the first camera 142d and the second camera 142e, by controlling the rotary motors.

Referring to (a) of FIG. 6, the processor 180 may acquire the image of the front region R1 using the first camera 142d and the second camera 142e. In this case, the first camera 142d and the second camera 142e may function as a stereo camera and thus the robot 100a may accurately detect a distance from a front obstacle, thereby efficiently controlling the traveling unit 160.

Referring to (b) and (c) of FIG. 6, the processor 180 may control the rotary motor such that the first camera 142d faces a first side or control the rotary motor such that the second camera 142e faces a second side.

That is, the processor 180 may acquire the image of a required region, by changing the capturing direction of any one of the first camera 142d or the second camera 142e according to the position of the robot 100a during passage through the crosswalk. Therefore, the image acquiring unit 142 may efficiently acquire the images of various required regions by a minimum number of cameras.

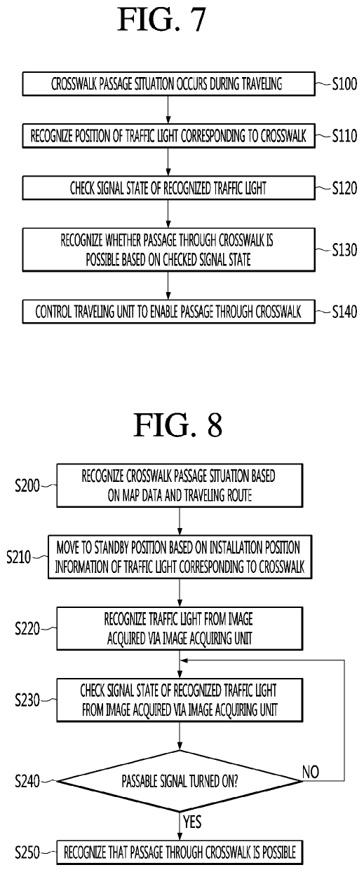

FIG. 7 is a flowchart illustrating a crosswalk passage method of a robot according to an embodiment of the present disclosure.

Referring to FIG. 7, a crosswalk passage situation may occur while the robot 100a travels (S100).

The robot 100a may travel to a destination, in order to provide a predetermined service (e.g., delivery of goods).

The processor 180 may control the traveling unit 160 based on the map data stored in the memory 170, a traveling route to the destination, and the position information of the robot 100a acquired via the position information module 116.

A crosswalk passage situation may occur while the robot 100a travels outdoors.

The map data may include information (position, length, etc.) on the crosswalk. Therefore, the processor 180 may recognize that the crosswalk passage situation occurs based on the map data.

Alternatively, the processor 180 may recognize that the crosswalk passage situation occurs, by recognizing the crosswalk from the image acquired via the image acquiring unit 142. For example, the processor 180 may input the image to a learning model (e.g., a machine learning based artificial neural network) trained to recognize the crosswalk included in the image, and acquire a result of recognition of the crosswalk from the learning model, thereby recognizing the crosswalk.

The robot 100a may recognize the position of the traffic light corresponding to the crosswalk (S110), and check the signal state of the recognized traffic light (S120).

The processor 180 may recognize the position of the traffic light corresponding to the crosswalk to be passed and check the signal state of the recognized signal light, thereby recognizing whether passage through the crosswalk is possible.

For example, the map data may include the position information of the traffic light corresponding to the crosswalk. The processor 180 may recognize the position of the traffic light based on the position information of the traffic light.

The processor 180 may periodically or continuously check the signal state of the traffic light. The signal state may include a state in which a non-passable signal (e.g., red light) is turned on and a passable signal (e.g., green light) is turned on.

The processor 180 may acquire an image including the traffic light via the image acquiring unit 142 and check the signal state from the acquired image. Similarly to crosswalk recognition, the processor 180 may check the signal state of the traffic light, by inputting the image to the learning model (artificial neural network, etc.) trained to recognize the signal state of the traffic light.

In some embodiments, the processor 180 may receive information on the state of the traffic light from a control device (not shown) of the traffic light via the communication interface 110, thereby checking the signal state.

The robot 100a may recognize that passage through the crosswalk is possible based on the checked signal state (S130), and control the traveling unit 160 to enable passage through the crosswalk (S140).

The processor 180 may recognize that passage through the crosswalk is possible, upon determining that the passable signal of the traffic light is turned on.

The processor 180 may control the traveling unit 160 to enable passage through the crosswalk according to the result of recognition.

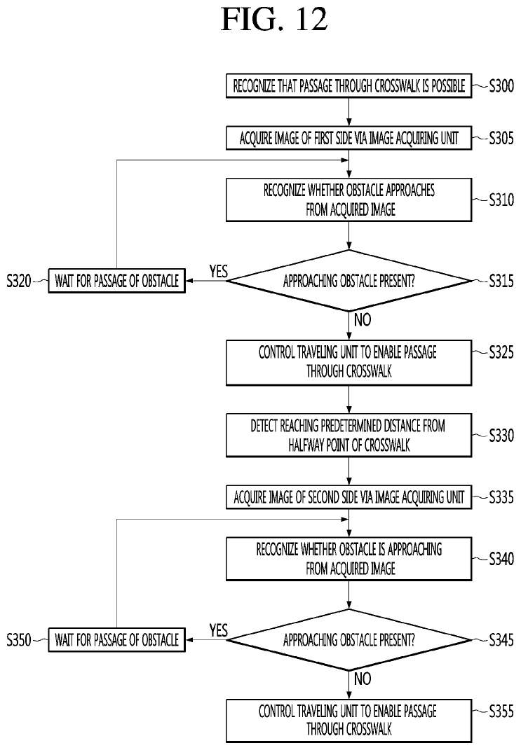

In some embodiments, the processor 180 may detect approaching of the obstacle using the image acquiring unit 142 before entering the crosstalk or while passing the crosswalk, and control the traveling unit 160 of the result of detection. This will be described in greater detail below with reference to FIGS. 12 to 15.

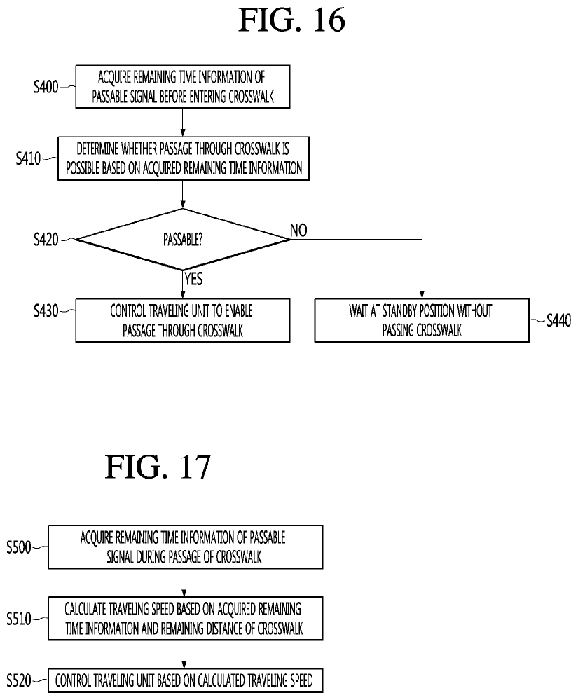

In some embodiments, the signal light may display the remaining time information of the passable signal using a number or a bar. In this case, the processor 180 may determine whether to enter the crosswalk based on the remaining time information or adjust the traveling speed when passing the crosswalk. This will be described in greater detail below with reference to FIGS. 16 to 17.

Hereinafter, an embodiment related to operation in which the robot 100a checks the signal state of the traffic light and recognizes whether passage through the crosswalk is possible will be described with reference to FIGS. 8 to 11.

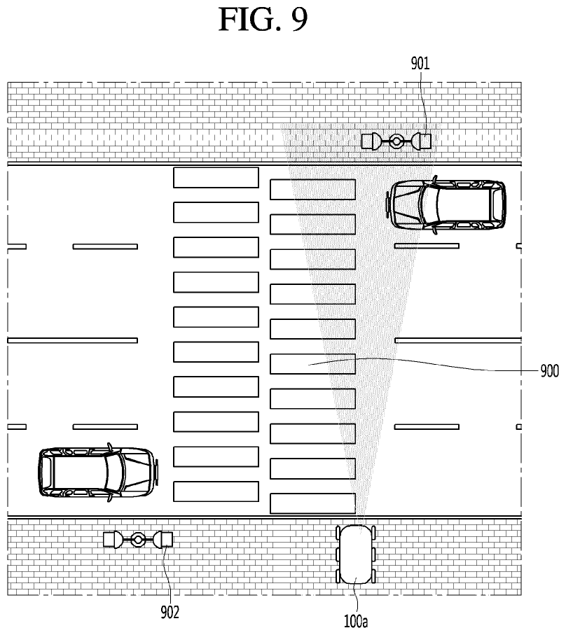

FIG. 8 is a flowchart illustrating operation in which a robot according to an embodiment of the present disclosure recognizes whether passage through a crosswalk via a traffic light corresponding to the crosswalk. FIGS. 9 to 11 are views showing examples related to operation of the robot shown in FIG. 8.

Referring to FIG. 8, the robot 100a may recognize a crosswalk passage situation based on map data and a traveling route (S200).

The processor 180 may recognize that the crosswalk passage situation occurs during traveling based on the map data and the traveling route. Alternatively, the processor 180 may recognize that the crosswalk passage situation occurs, by recognizing the crosswalk from the image acquired via the image acquiring unit 142.

The robot 100a may move to a standby position based on the position information of the traffic light corresponding to the crosswalk (S210).

The processor 180 may move to the standby position based on the position information of the traffic light included in the map data.

The processor 180 may set the standby position based on the position information of the traffic light.

Referring to FIG. 9, the processor 180 may acquire the position information of the traffic light 901 of the crosswalk 900 from the map data.

The processor 180 may set a position facing the traffic light 901 as the standby position of the robot 100a, in order to more easily recognize the signal state of the traffic light 901 later using the image acquiring unit 142.

In some embodiments, the position facing the traffic light 901 may be the outside of a region corresponding to the crosswalk 900. In this case, the processor 180 may set a position closest to the position facing the traffic light 901 of the region (sidewalk region) corresponding to the crosswalk 900 as the standby position. In this case, the robot 100a may wait at the position shown in FIG. 9.

However, the method of setting the standby position is not limited thereto and the robot 100a may set the standby position according to various setting methods.

FIG. 8 will be described again.

The robot 100a may recognize the traffic light from the image acquired via the image acquiring unit 142 (S220).

The processor 180 may acquire an image including a region corresponding to the position information of the traffic light via the image acquiring unit 142, when the robot 100a is located at the standby position. When an obstacle is not present between the traffic light and the robot 100a, the image may include the traffic light.

The processor 180 may recognize the traffic light from the acquired image via a known image recognition scheme.

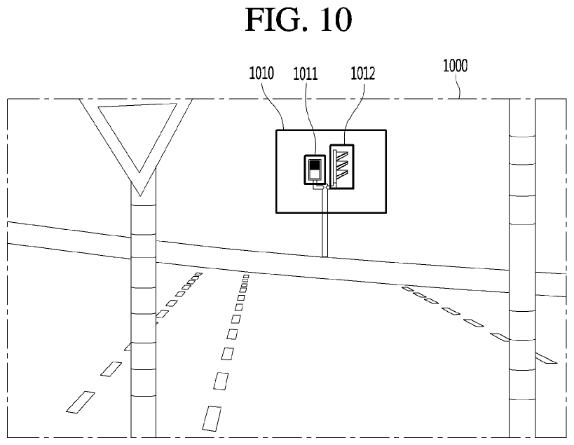

Referring to FIG. 10, the processor 180 may extract a region 1010, in which the traffic light is estimated to be present, from the image 1000 acquired via the image acquiring unit 142.

For example, the processor 180 may extract a region 1010, in which the traffic light is estimated to be present, of the image 1000 based on the position information of the traffic light (e.g., three-dimensional coordinates), the position (standby position) of the robot 100a, and the direction of the image acquiring unit 142.

The processor 180 may recognize at least one traffic light 1011 and 1012 included in the extracted region 1010 via a known image recognition scheme.

In some embodiments, the processor 180 may recognize at least one traffic light 1011 and 1012 included in the extracted region 1010 using a learning model trained to recognize the traffic light from the image. For example, the learning model may include an artificial neural network trained based on machine learning, such as a convolutional neural network (CNN).

The processor 180 may recognize the traffic light 1011 corresponding to the crosswalk of the recognized at least one traffic light 1011 and 1012. For example, the processor 180 may recognize the traffic light 1011 corresponding to the crosswalk, based on the direction of each of the recognized at least one traffic light 1011 and 1012, the size of the region corresponding to a turned-on signal and the installation form according to the installation regulations of the traffic light.

FIG. 8 will be described again.

The robot 100a may check the signal state of the recognized traffic light from the image acquired via the image acquiring unit 142 (S230).

The processor 180 may control the image acquiring unit 142 to periodically or continuously acquire the image including the traffic light recognized in step S220.

The processor 180 may check the signal state of the traffic light from the acquired image. For example, the processor 180 may check the signal state by recognizing the color, shape and position of the currently turned on signal with respect to the traffic light, without being limited thereto.

Meanwhile, the processor 180 may differently adjust the first field of view (or the angle of view) of the image acquiring unit 142 (camera) when the robot 100a travels on a sidewalk and a second field of view (or the angle of view) of the image acquiring unit 142 when the image including the traffic light is acquired. For example, the first field of view may be wider than the second field of view. Therefore, the processor 180 may smoothly detect objects located at various positions and in various directions based on the first field of view while the robot 100a travels on a sidewalk, and more concentratively check the state of the traffic light based on the second field of view when the state of the traffic light is checked.

When the passable signal is not turned on (NO of S240) as the result of checking, the robot 100a may continuously check the signal state while waiting at the standby position.

As shown in FIG. 10, when the non-passable signal (e.g., red light) of the traffic light 1011 is turned on, the processor 180 may recognize that passage through the crosswalk is impossible.

In contrast, when the passable signal is turned on (YES of S240) as the result of checking, the robot 100a may recognize that passage through the crosswalk is possible (S250).

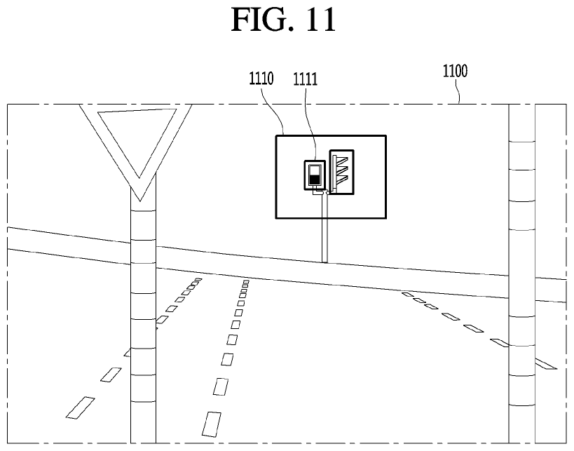

As shown in FIG. 11, when the passable signal (e.g., green light) of the signal light 111 is turned on, the processor 180 may recognize that passage through the crosswalk is possible.

That is, according to the embodiments shown in FIGS. 8 to 11, the robot 100a may recognize whether passage through the crosswalk is possible, by checking the signal state of the traffic light via the image acquiring unit 142.

Therefore, even if a separate traffic light control device for transmitting the signal state information of the traffic light to the robot 100a via wireless communication is not provided, since the robot 100a can recognize whether passage through the crosswalk is possible, it is possible to reduce cost required to establish the system.

In addition, even in a state in which reception of the signal state information via wireless communication is impossible, the robot 100a may recognize whether passage through the crosswalk is possible via the image acquiring unit 142 and safely pass the crosswalk.

Hereinafter, embodiments related to control operation for enabling the robot 100a to pass the crosswalk will be described with reference to FIGS. 12 to 15.

FIG. 12 is a flowchart illustrating control operation when a robot according to an embodiment of the present disclosure passes a crosswalk.

Referring to FIG. 12, the robot 100a may recognize that passage through the crosswalk is possible based on the signal state of the traffic light (S300).

Step S300 has been described above with respect to FIGS. 7 to 11 and thus a description thereof will be omitted.

The robot 100a may acquire the image of a first side (or a first front side) via the image acquiring unit 142 (S305), and recognize whether an obstacle is approaching from the acquired image (S310).

As described above with reference to FIGS. 5 to 6, the most dangerous obstacle when the robot passes the crosswalk may be a vehicle traveling on a driveway.

The processor 180 may acquire the image of the first side (or the first front side) using any one of at least one camera included in the image acquiring unit 142. For example, in the embodiment of FIG. 5, the processor 180 may activate any one of the second camera 142b and the third camera 142c and deactivate the other camera, thereby acquiring the image of the first side.

The first side may be related to the traveling direction of the vehicle.

For example, when a driveway in which the crosswalk is installed is a one-way driveway, the first side may correspond to a direction in which a vehicle traveling forward approaches the crosswalk. In addition, when the driveway is a one-way driveway, steps S330 to S355 may not be performed.

In contrast, when a driveway in which the crosswalk is installed is a two-way driveway and has a right passage method, the first side may correspond to the left. In addition, when the driveway has a left passage method, the first side may correspond to the right.

That is, the processor 180 may acquire the image in a direction in which a vehicle may approach during passage through the crosswalk and recognize whether an obstacle (in particular, a vehicle) is approaching from the acquired image.

However, the obstacle is not limited to the vehicle and may include various objects such as a pedestrian or an animal.

Meanwhile, while the image of the first side is acquired and approaching of an obstacle is recognized, the first camera 142a may be continuously activated. In this case, the processor 180 may highly set the priority of processing the first side image between the front image and first side image acquired by the first camera 142a. Therefore, the processor 180 may more rapidly and accurately detect whether an obstacle is approaching from the first side image.

When the approaching obstacle is recognized (YES of S315), the robot 100a may wait for passage of the obstacle (S320). In contrast, when the approaching obstacle is not recognized (NO of S315), the robot 100a may control the traveling unit 160 to pass the crosswalk (S325).

The processor 180 may periodically or continuously the image of the first side via the image acquiring unit 142. The processor 180 may recognize at least one obstacle from the acquired image.

In addition, the processor 180 may estimate the movement direction and movement speed of the obstacle from the periodically or continuously acquired image. The processor 180 may recognize whether an obstacle is approaching based on the estimated movement direction and movement speed.

When the approaching obstacle is recognized, the processor 180 may wait for passage of the obstacle. That is, the processor 180 may wait until it is recognized that the obstacle is no longer approaching, without entering the crosswalk.

In some embodiments, when the approaching obstacle is recognized, the processor 180 may control the traveling unit 160 to avoid the obstacle such that the robot enters the crosswalk. For example, when the movement speed of the approaching obstacle is low, the processor 180 may control the traveling unit 160 to avoid approaching of the obstacle.

Meanwhile, the processor 180 may wait for passage of the obstacle when collision between the recognized obstacle and the robot 100a is predicted.

Specifically, the processor 180 may predict whether the obstacle and the robot 100a collide, using the traveling direction and traveling speed of the robot 100a when the robot enters the crosswalk and the movement direction and movement speed of the recognized obstacle.

When collision between the obstacle and the robot 100a is predicted, the processor 180 may perform control such that the robot waits until collision with the obstacle is no longer predicted (passage of the obstacle, etc.) without entering the crosswalk.

When approaching of the obstacle is not recognized or collision with the obstacle is not predicted, the processor 180 may control the traveling unit 160 such that the robot enters and passes the crosswalk.

In some embodiments, the processor 180 may continuously detect whether an obstacle is approaching via the image acquiring unit 142, etc. even during passage through the crosswalk, and control the traveling unit 160 to avoid collision with the obstacle.

Meanwhile, the processor 180 may differently adjust the first field of view (or the angle of view) of the image acquiring unit 142 (camera) when the robot 100a travels on a sidewalk and a second field of view (or the angle of view) of the image acquiring unit 142 when approaching of the obstacle is recognized during passage through the crosswalk.

For example, the first field of view may be wider than the second field of view.

Accordingly, the processor 180 may smoothly detect objects present at various positions and in various directions, by setting the field of view (angle of view) of the image acquiring unit 142 (e.g., the first camera 142a to the third camera 142c) to a first field of view while the robot 100a travels on a sidewalk. In addition, the processor 180 may more accurately analyze and recognize whether an obstacle is approaching in a specific region (e.g., a region having a high possibility of collision or a region close to the robot), by setting the field of view (angle of view) of the image acquiring unit 142 (e.g., the second camera 142b or the third camera 142c) to a second field of view narrower than the first field of view, when recognizing approaching of the obstacle for passage through the crosswalk.

In some embodiments, the processor 180 may differently set a first frame rate of the image acquiring unit 142 (camera) when the robot 100a travels on the sidewalk and a second frame rate of the image acquiring unit 142 when approaching of the obstacle is recognized in the cross passage situation. For example, the second frame rate may be set to be higher than the first frame rate. Therefore, the processor 180 may more rapidly and accurately analyze and recognize whether the obstacle is approaching in the crosswalk passage situation.

The robot 100a may detect reaching a predetermined distance from the halfway point of the crosswalk (S330), and acquire the image of the second side (the second front side) via the image acquiring unit 142 (S335). The robot 100a may recognize whether an obstacle is approaching from the acquired image (S340).

When the driveway in which the crosswalk is installed is a two-way driveway, the passage directions of vehicles are opposite to each other with respect to the halfway point of the crosswalk.

The processor 180 may detect that the robot 100a reaches the predetermined distance from the halfway point of the crosswalk, based on the position information of the robot 100a acquired from the position information module 116, the front image acquired via the image acquiring unit 142, the movement distance of the robot 100a, etc.

When it is detected that the robot 100a reaches the predetermined distance from the halfway point of the crosswalk, the processor 180 may control the image acquiring unit 142 to acquire the image of the second side. For example, in the embodiment of FIG. 5, the processor 180 may activate the activated camera between the second camera 142b and the third camera 142c and deactivate the deactivated camera.

The processor 180 may recognize approaching of an obstacle from the acquired image of the second side.

Meanwhile, in the embodiment of FIG. 12, the front image of the robot 100a may be continuously acquired, in order to check the signal state of the traffic light or recognize the obstacle located at the front side of the robot 100a.

When the approaching obstacle is recognized (YES of S345), the robot 100a may wait for passage of the obstacle (S350). In some embodiments, the robot 100a may control the traveling unit 160 to avoid the approaching obstacle.

When the approaching obstacle is not recognized (NO of S345), the robot 100a may control the traveling unit 160 to pass the crosswalk (S355).

Steps S340 to S355 may be similar to steps S310 to S325 and a detailed description thereof will be omitted.

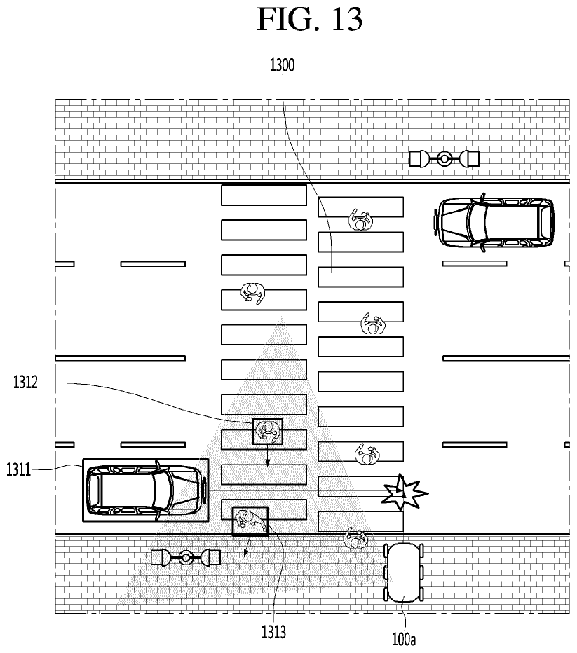

FIGS. 13 to 15 are views showing examples related to operation of the robot shown in FIG. 12.

Referring to FIG. 13, the robot 100a may recognize that passage through the crosswalk 1300 is possible, by determining that the passable signal of the traffic light is turned on while waiting at the standby position for passage through the crosswalk 1300.

The processor 180 may control the image acquiring unit 142 to acquire the image of the first side before entering the crosswalk 1300.

When the driveway in which the crosswalk 1300 is installed is a two-way driveway and has a right passage method, the processor 180 may control the image acquiring unit 142 to acquire the image of the left.

The processor 180 may recognize a first obstacle 1311, a second obstacle 1312 and a third obstacle 1313 from the acquired image.

The processor 180 may estimate the movement directions and movement speeds of the recognized obstacles 1311 to 1313 using a plurality of images.

The processor 180 may predict whether the obstacles 1311 to 1313 and the robot 100a collide, based on the result of estimation and the traveling direction and traveling speed when the robot 100a enters the crosswalk.

For example, when it is predicted that the first obstacle 1311 collides with the robot 100a, the processor 180 may control the traveling unit 160 to wait at the standby position without entering the crosswalk 1300.

In contrast, when collision between the recognized obstacles 1311 to 1313 and the robot 100a is not predicted, the processor 180 may control the traveling unit 160 to enter the crosswalk 1300.

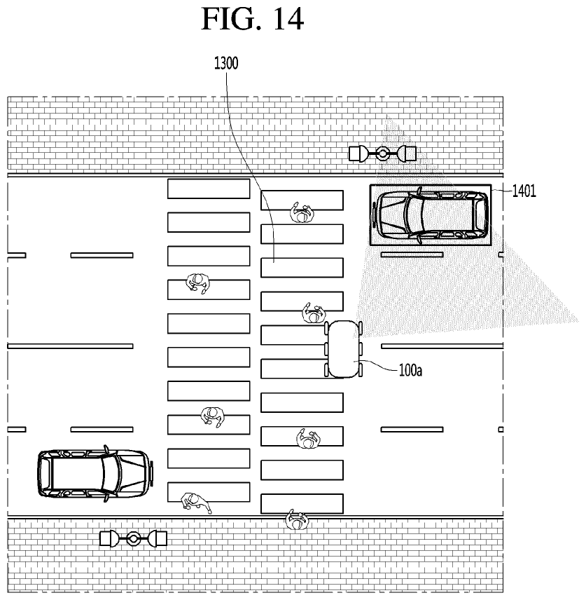

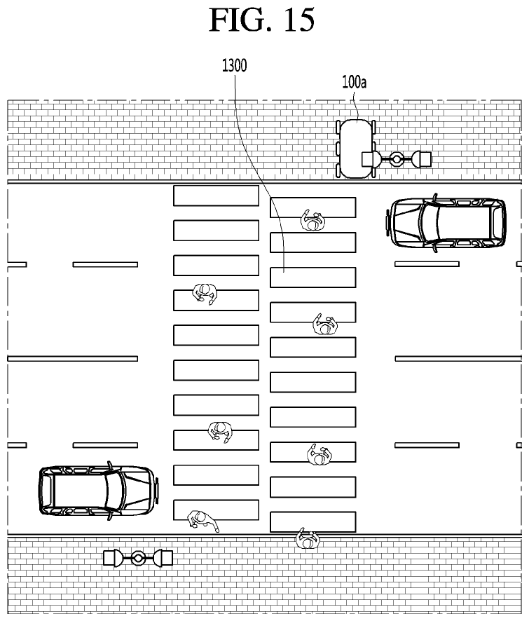

Referring to FIGS. 14 to 15, the processor 180 may detect whether the robot 100a which is passing the crosswalk 1300 reaches a predetermined distance from the halfway point of the crosswalk 1300.

When it is determined that the robot reaches the predetermined distance from the halfway point, the processor 180 may control the image acquiring unit 142 to acquire the image of the second side. For example, according to the embodiment of FIG. 5, the processor 180 may deactivate the second camera 142b and activate the third camera 142c. That is, the processor 180 may activate only any one of the second camera 142b and the third camera 142c, thereby efficiently driving the cameras.

The processor 180 may recognize an obstacle 1401 from the acquired image of the second side and estimate the movement direction and movement speed of the recognized obstacle 1401. For example, when it is estimated that the obstacle 1401 is in a stopped state, the processor 180 may complete passage through the crosswalk, by controlling the traveling unit 160 to enable passage through the remaining section of the crosswalk.

That is, according to the embodiments of FIGS. 12 to 15, the robot 100a may safely pass the crosstalk by detecting the obstacle using the image acquiring unit 142.

In addition, the robot 100a may selectively activate the camera of the image acquiring unit 142 according to the passage point of the crosswalk to acquire and process only the image of a required region, thereby rapidly recognizing the obstacle and efficiently performing the processing operation of the processor.

FIG. 16 is a flowchart illustrating an embodiment related to a crosswalk passage method of a robot.

Referring to FIG. 16, the robot 100a may acquire the remaining time information of the passable signal of the traffic light before entering the crosswalk (S400).

The traffic light may display the remaining time of the passable signal in the form of a number or a bar, in addition to the non-passable signal and the passable signal.

The processor 180 may acquire information on the remaining time displayed via the traffic light from the image acquired via the image acquiring unit 142.

The robot 100a may determine whether passage through the crosswalk is possible based on the acquired remaining time information (S410).

The processor 180 may determine whether passage through the crosswalk is possible based on at least one of the remaining time of the passable signal, the distance of the crosswalk or the traveling speed of the robot 100a.

Specifically, the processor 180 may calculate a time required to pass the crosswalk based on the distance of the crosswalk and the traveling speed of the robot 100a. The processor 180 may determine whether passage through the crosswalk is possible via comparison between the calculated time and the remaining time.

Upon determining that passage through the crosswalk is possible (YES of S420), the robot 100a may control the traveling unit to pass the crosswalk (S430).

For example, when the calculated time is less than the remaining time by a reference time or more, the processor 180 may recognize that passage through the crosswalk is possible. Since the time required to pass the crosswalk may increase when the traveling environment is changed by an obstacle when the robot passes the crosswalk, the processor 180 may recognize that passage through the crosswalk is possible when the calculated time is less than the remaining time by the reference time or more.

The processor 180 may control the traveling unit 160 such that the robot 100a passes the crosswalk. Control operation of the robot 100a during passage through the crosswalk is applicable to the embodiments described above with reference to FIGS. 12 to 15.

In contrast, upon determining that passage through the crosswalk is impossible (NO of S420), the robot 100a may wait at a standby position until a next passable signal is turned on without passing the crosswalk (S440).

For example, when the calculated time is greater than the remaining time or when a sum of the calculated time and the reference time is greater than the remaining time, the processor 180 may recognize that passage through the crosswalk is impossible.

In this case, the processor 180 may control the traveling unit 160 to wait at the standby position until the next passable signal is turned on.

That is, the robot 100a may enter the crosswalk after determining whether there is a time enough to pass the crosswalk, thereby safely passing the crosswalk.

FIG. 17 is a flowchart illustrating an embodiment related to a crosswalk passage method of a robot.

Referring to FIG. 17, the robot 100a may acquire the remaining time information of the passable signal of the traffic light during passage through the crosswalk (S500).

The robot 100a may calculate the traveling speed of the robot 100a for passage through the crosswalk based on the acquired remaining time information and the remaining distance of the crosswalk (S510).

The processor 180 may recognize the position of the robot 100a based on the position information acquired via the position information module 116 or the image acquired via the image acquiring unit 142.

The processor 180 may calculate the remaining distance of the crosswalk based on the recognized position.

The processor 180 may calculate the traveling speed for enabling the robot 100a to completely pass the crosswalk before the passable signal is turned off, based on the calculated remaining distance and the remaining time information.

The robot 100a may control the traveling unit 160 based on the calculated traveling speed, thereby completely passing the crosswalk before the passable signal is turned off (S520).

According to the embodiment shown in FIG. 17, when passage through the crosswalk is delayed due to an obstacle during passage through the crosswalk, the robot 100a may safely pass the crosswalk, by increasing the traveling speed based on the remaining time and the remaining distance.

According to the embodiment of the present disclosure, the robot can safely pass the crosswalk, by detecting an obstacle using the image acquiring unit including at least one camera.

In addition, the robot may selectively activate the camera of the image acquiring unit according to the passage point of the crosswalk to acquire and process only the image of a required region, thereby rapidly recognizing the obstacle and efficiently performing the processing operation of the processor.

Further, the robot can recognize whether passage through the crosswalk is possible via the image acquiring unit, thereby reducing cost required to establish a separate system for transmitting the signal state information of the traffic light to the robot via wireless communication. In addition, even in a state in which reception of the signal state information via wireless communication is impossible, the robot can recognize whether passage through the crosswalk is possible via the image acquiring unit, thereby safely passing the crosswalk.

The foregoing description is merely illustrative of the technical idea of the present disclosure, and various changes and modifications may be made by those skilled in the art without departing from the essential characteristics of the present disclosure.

Therefore, the embodiments disclosed in the present disclosure are to be construed as illustrative and not restrictive, and the scope of the technical idea of the present disclosure is not limited by these embodiments.

The scope of the present disclosure should be construed according to the following claims, and all technical ideas within equivalency range of the appended claims should be construed as being included in the scope of the present disclosure.

1. A robot comprising:
at least one motor configured to move the robot;
a memory configured to store map data;
at least one camera; and
a processor configured to:
determine, while the robot is moving, whether a crosswalk passage situation occurs based on the map data and a traveling route,
determine a signal state of a traffic light associated with a crosswalk in the crosswalk passage situation based on a determination that the crosswalk passage situation occurs,
determine whether passage through the crosswalk is possible based on the determined signal state, and
control the at least one motor to move the robot through the crosswalk based on a determination that passage through the crosswalk is possible.

2. The robot of claim 1,
wherein the map data includes position information of the crosswalk, and
wherein the crosswalk passage situation is determined based on the position information of the crosswalk and a location of the robot.

3. The robot of claim 2,
wherein the map data further includes position information of the traffic light corresponding to the crosswalk, and
wherein the processor is further configured to:
control the at least one camera to capture an image including the traffic light based on the position information of the traffic light, and
determine the signal state of the traffic light based on the captured image.

4. The robot of claim 3, wherein the processor is further configured to:
set a standby position based on the position information of the traffic light, and
control the at least one motor to stop at the set standby position.

5. The robot of claim 4, wherein the standby position is set to a position facing the traffic light in a sidewalk region corresponding to the crosswalk.

6. The robot of claim 3, wherein the processor is further configured to:
determine at least one of a color, a shape or a position of a turned-on signal of the traffic light based on the captured image, and
wherein the passage through the crosswalk is determined to be possible based on the determination of the turned-on signal of the traffic light.

7. The robot of claim 3, wherein the processor is further configured to obtain a result of determining the signal state from the captured image via a learning model trained based on machine learning to determine the signal state of the traffic light.

8. The robot of claim 1,
wherein the processor is further configured to capture an image of a first side via the at least one camera when it is determined that passage through the crosswalk is possible, and
wherein the first side is determined based on a vehicle traveling direction of a street in which the crosswalk is installed.

9. The robot of claim 8, wherein the processor is further configured to:
determine at least one obstacle from the captured image of the first side, and
control the at least one motor to move the robot based on the determined at least one obstacle.

10. The robot of claim 9, wherein the processor is further configured to control the at least one motor to not enter the crosswalk when approaching the determined at least one obstacle.

11. The robot of claim 9, wherein the processor is further configured to:
determine a movement direction and a movement speed of each of the at least one obstacle from the captured image of the first side,
predict whether the at least one obstacle and the robot will collide based on the determination of the movement direction and the movement speed, and
control the at least one motor not to enter the crosswalk when a collision is predicted.

12. The robot of claim 11, wherein the processor is further configured to control the at least one motor to enter the crosswalk when a collision is not predicted.

13. The robot of claim 12, wherein the processor is further configured to:
determine that the robot reaches a predetermined distance from a point of the crosswalk based on a position information of the robot or the captured image,
control the at least one camera to capture an image of a second side opposite to the first side, and
control the at least one motor based on the captured image of the second side.

14. The robot of claim 13,
wherein the at least one camera includes:
a first camera disposed to face a front side of the robot;
a second camera disposed to face the first side of the robot; and
a third camera disposed to face the second side of the robot, and
wherein the processor is configured to selectively activate at least one of the second camera or the third camera to capture the image of the first side or the image of the second side.

15. The robot of claim 1, wherein the processor is further configured to:
obtain remaining time information of a passable signal of the traffic light corresponding to the crosswalk before entering the crosswalk,
determine whether passage through the crosswalk is possible based on the obtained remaining time information, and
control the at least one motor to move the robot through the crosswalk or wait at a standby position of the crosswalk based on the determination of whether passage through the crosswalk is possible.

16. The robot of claim 1, wherein the processor is further configured to:
obtain remaining time information of a passable signal of the traffic light during passage through the crosswalk,
determine a traveling speed based on the obtained remaining time information and a remaining distance of the crosswalk, and
control the at least one motor according to the determined traveling speed.

17. A robot comprising:
at least one motor configured to move the robot;
a memory configured to store map data;
at least one camera; and
a processor configured to:
determine, while the robot is moving, whether a crosswalk passage situation occurs based on the map data,
control the at least one camera to capture a side image with respect to the robot,
determine whether passage through a crosswalk is possible based on the captured side image, and
control the at least one motor to move the robot through the crosswalk based on a determination that passage through the crosswalk is possible.

18. The robot of claim 17,
wherein the at least one camera includes:
a first camera configured to a front image with respect to the robot;
a second camera configured to capture a first side image with respect to the robot; and
a third camera configured to capture a second side image with respect to the robot, and
wherein the processor is further configured to cause at least one of the second camera or the third camera to capture the side image with respect to the robot based on a determination that the crosswalk passage situation occurs.

19. The robot of claim 18, wherein the processor is configured to set a priority of processing the side image to be higher than priority of processing the front image.

20. The robot of claim 18,
wherein each of the at least one camera is rotatable about a vertical axis,
wherein the robot includes at least one rotary motor for rotating the at least one camera, and
wherein the processor is further configured to:
control a rotary motor of the at least one rotary motor corresponding to the first camera to capture the side image via the first camera based on a determination that the crosswalk passage situation of the crosswalk occurs,
capture a front image with respect to the robot via the second camera, and
set priority of processing the side image to be higher than priority of processing the front image.
